(19) United States
(12) Patent Application Publication
(10) Pub. No.: US 2018/0098272 A1
(43) Pub. Date: Apr. 5, 2018

(54) Cross-Transport Network Connection State Detection and Management Engine

(71) Applicant: Microsoft Technology Licensing, LLC, Redmond, WA (US)

(72) Inventors: Anthony Goodrich Jones, Kirkland, WA (US); Ellick Hung-Zhi Sung, Seattle, WA (US); Keith Edgar Horton, North Bend, WA (US); Vu Phan Hoang Nguyen, Lynnwood, WA (US); Jayesh Bhatia, Sammamish, WA (US)

(73) Assignee: Microsoft Technology Licensing, LLC, Redmond, WA (US)

(21) Appl. No.: 15/627,827

(22) Filed: Jun. 20, 2017

Related U.S. Application Data
(60) Provisional application No. 62/404,384, filed on Oct. 5, 2016.

(51) Int. Cl. H04W 48/16; H04W 8/18

(52) U.S. Cl. CPC H04W 48/16; H04W 28/0215; H04W 8/18

(57) ABSTRACT

Described herein is an extensible connection management framework comprising a computer comprising a processor and a memory. The memory comprises a connection management system comprising a route management engine configured to select a policy from a policy store in response to a received input trigger, the route manager further configured to apply the selected policy to facilitate communication between the computer and another computer to transition from a Wi-Fi network to a cellular network, wherein the input trigger is received from a component of the computer and provide information regarding at least one of a a user of the computer or a communication modality.

### RELATED APPLICATION

This application claims priority to U.S. Provisional Application No. 62/404,384, filed Oct. 5, 2016, entitled “Cross-Transport Network Connection State Detection and Management Engine”, the entire disclosure of which is hereby incorporated by reference herein in its entirety.

### BACKGROUND

Use of communication modalities can have a significant impact on a user's experience with a computing device. For example, slow, non-responsive Internet access via a Wi-Fi connection can be frustrating for the user. Also, anxiety associated with costs of over utilization of costly cellular connections can reduce the user's enjoyment of the computing device.

### SUMMARY

Described herein is an extensible connection management framework comprising a computer comprising a processor and a memory. The memory comprises a connection management system comprising a route management engine configured to select a policy from a policy store in response to a received input trigger, the route manager further configured to apply the selected policy to facilitate communication between the computer and another entity (e.g., computing device available via a cellular network, cloud-based and the like) to transition from a Wi-Fi network to a cellular network, wherein the input trigger is received from a component of the computer and provide information regarding at least one of a hardware component, a software application, an operating system, a user of the computer or a communication modality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates an extensible communication management framework.

FIG. 2 illustrates an exemplary methodology of a method of facilitating an extensible connection management framework.

FIG. 3 illustrates an exemplary methodology of a method of facilitating an extensible connection management framework.

FIG. 4 is a functional block diagram that illustrates an extensible communication management framework.

FIG. 5 illustrates an exemplary methodology of a method of route management.

FIG. 6 further illustrates the exemplary methodology of FIG. 5.

FIG. 7 is a functional block diagram that illustrates an exemplary computing system.

### DETAILED DESCRIPTION

Various technologies pertaining to an extensible connection management framework are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding an extensible connection management framework. What follows are one or more exemplary systems and methods.

Aspects of the subject disclosure pertain to the technical problem of managing computer communication connection(s). For example, input trigger(s) (e.g., asynchronous input trigger(s) and/or synchronous input trigger(s)) can be dynamically utilized to select a particular communication connection based upon defined policy(ies) (e.g., user-defined policy(ies)). The technical features associated with addressing this problem involve defining policy(ies) that associate one or more particular input trigger(s) with a particular communication connection. These policy(ies) can take into consideration, for example, context information about a user, context information about a location of a computing device, context information about the computing device, information about the nature of the communication and the like. In this manner, a user experience can be enhanced, for example, by utilizing a best mode of communication, for example, at a particular time, for the particular user in view information regarding current connection status.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

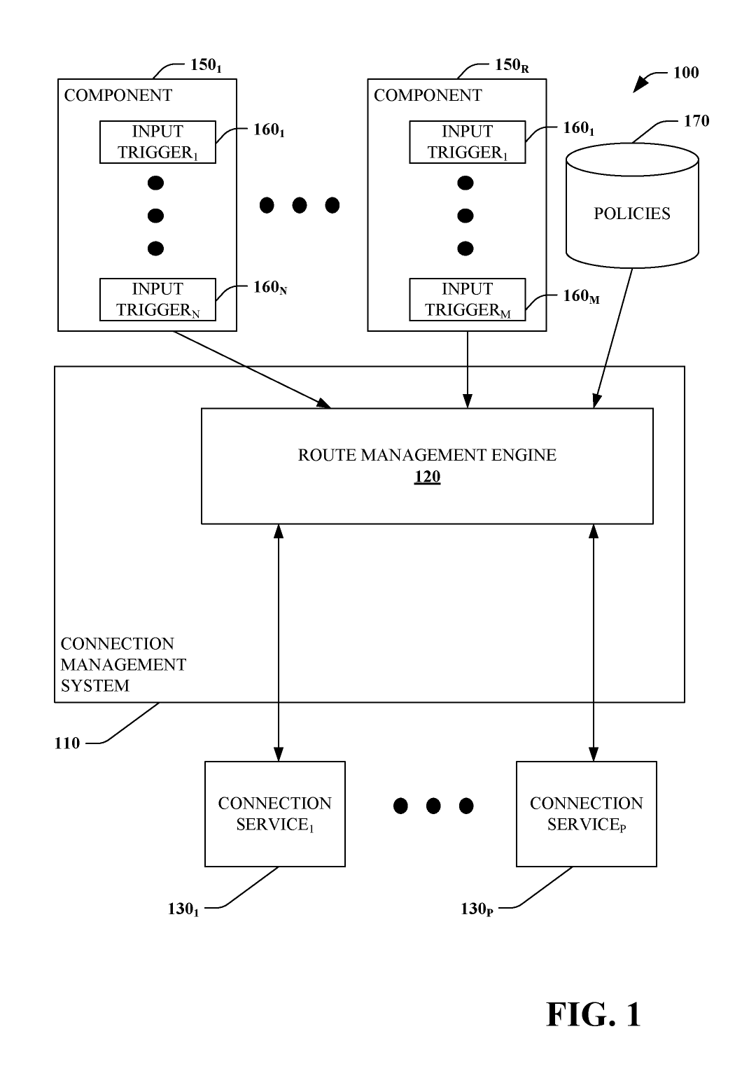

Referring to FIG. 1, an extensible connection management framework 100 is illustrated. The framework 100 can utilize policies (e.g., user-defined) to increase user satisfaction with the user's experience with a computing device of which the framework 100 is a component.

The framework 100 includes a connection management system 110 comprising a route management engine 120 and a plurality of connection configuration services 130. The connection services 130 provide functionality to add and/or delete a particular communication modality and/or channel of communication.

The framework 100 further includes a plurality of components 150. Each of the plurality of component 150 can be associated with a particular component of a computing device such as hardware, software applications and/or operating system, a user of the computing device, communication modalities and the like. Each of the components 150 can include one or more input triggers 160 that can provide information about a user, information about a location of a computing device, information about the computing device, information about communication modality(ies) of the computing device and the like. For example, input trigger(s) can be asynchronous and/or synchronous.

Based upon these input triggers and policy(ies) stored in the policy store 170, the route management engine can dynamically select a particular communication connection based upon defined policy(ies) (e.g., user-defined policy(ies) stored in the policy store 170. These policy(ies) stored in the policy store 170 can take into consideration, for example, context information about a user, context information about a location of a computing device, context information about the computing device, information about the nature of the communication and the like. In this manner, a user experience can be enhanced, for example, by utilizing a best mode of communication, for example, at a particular time, for the particular user in view information regarding current connection status.

The framework 100 thus provides a centralized, flexible, extensible mechanism by which individual layer(s) from associated communication modality(ies) (e.g., or even individual connection(s)) can provide input for specific use cases to a single management component (e.g., at the top of stack), for example, the route management engine 120. The route management engine 120 can make decisions to use a best available connection for each specific use case. Additionally, pre-provisioned policies stored in a policy store 170 can be used to impact the decisions made by the route management engine 120.

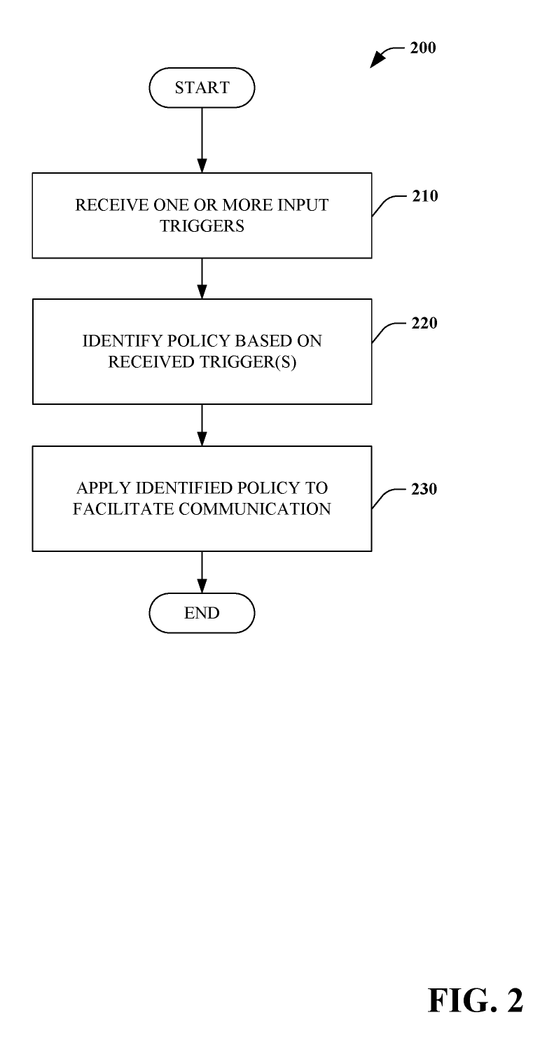

FIGS. 2, 3, 5 and 6 illustrate exemplary methodologies relating to an extensible connection management framework. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Turning to FIG. 2, a method of facilitating an extensible connection management framework 200 is illustrated. At 210, one or more input triggers are received, for example, from component(s) 150. At 220, one or more policies are identified based upon the received input trigger(s). At 230, an identified policy is applied to facilitate communication. In one embodiment, the policies are arranged hierarchically such that the highest ranking identified policy is utilized to facilitate communication.

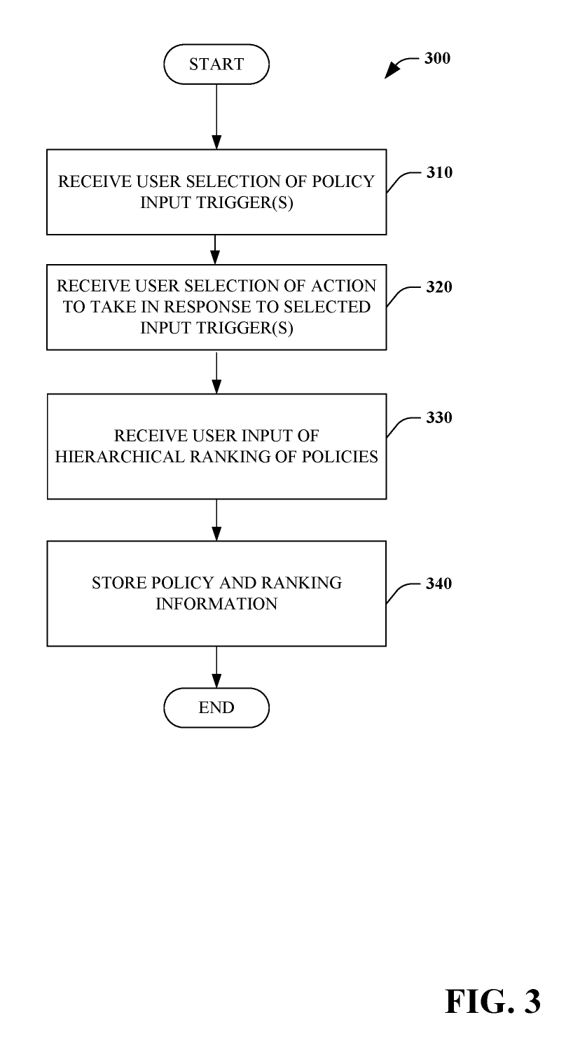

Referring next to FIG. 3, a method of facilitating an extensible connection management framework 300 is illustrated. At 310, a user selection one or more policy input trigger(s). At 320, user selection of an action to take in response to selection input trigger(s) (e.g., selection of particular communication modality) is received. At 330, a user input of a hierarchical ranking of policies is received. At 340, the policy and ranking information is stored.

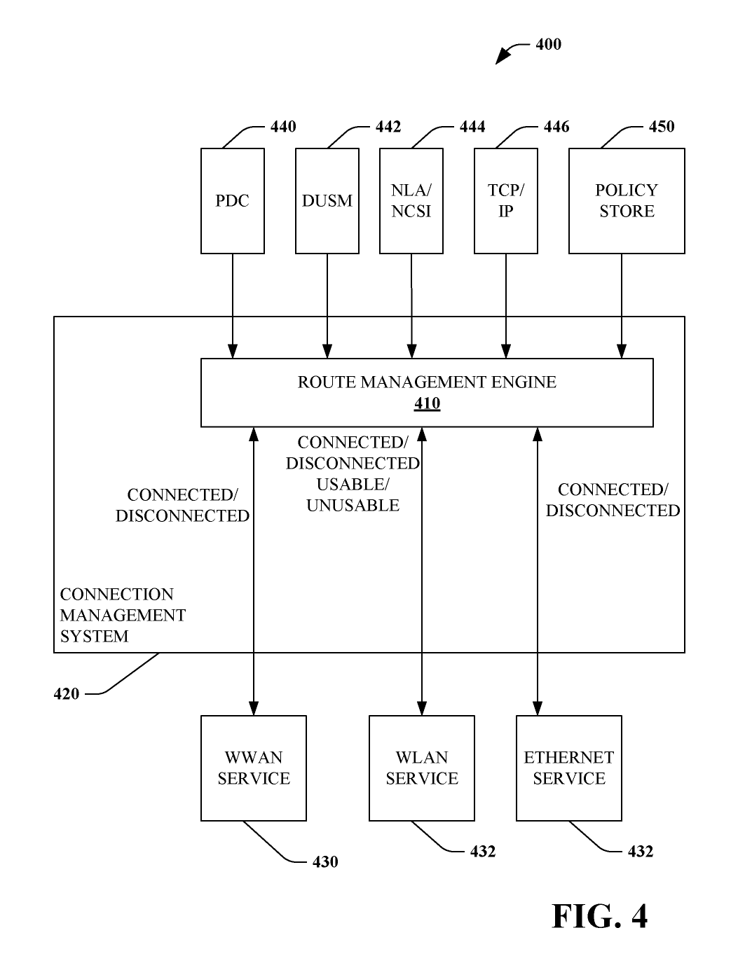

Turning to FIG. 4, an extensible connection management framework 400 is illustrated. The framework 400 can utilize policy(ies) (e.g., user-defined) to increase user satisfaction with the user's experience with a computing device of which the framework 400 is a component.

The framework 400 leverages information about a state of a network connection(s) at various layer(s) of different network stack(s) (e.g., but specific to its own layer). In one embodiment, each layer of each stack handling communication across a particular communication modality (e.g., Wi-Fi, Ethernet, cellular, etc.) is aware of information particular to that communication modality. The framework 400 can utilize this granular information, for example, to identify potential problem(s) with a particular communication modality and to proactively select another communication modality based upon the policy(ies).

A centralized, flexible, extensible framework 400 is thus provided by which individual layer(s) from associated communication modality(ies) (e.g., or even individual connection(s)) can provide input for specific use cases to a single management component (e.g., at the top of stack), for example, a route management engine 410, as discussed below. This route management engine 410 can make decisions to use the best available connection for each specific use case. Additionally, pre-provisioned policies can be used to impact the decisions made by the route management engine 410.

In one embodiment, the framework 400 can be used to improve detection of when a Wi-Fi connection has become unusable for an end user and will temporarily direct Internet connections to a cellular network, if available. This improves the user scenario where an end user may be “stuck” on a very poor (unusable) quality Wi-Fi link that is unable to sustain any data throughput. The input triggers used in this embodiment can include existing Dead Gateway Detection (DGD) logic from the Transmission Connection Protocol (TCP) layer, existing Neighbor Unreachable Detection (NUD) from the Internet Protocol (IP) layer, and the existing Network Location Awareness (NLA) state as provided to the Network Connection Status Indicator (NCSI). Combined, these indicators can provide advanced detection of when Wi-Fi may be connected but has started failing, allowing the operating system to switch, via the connection management system 420, the user to a different available connection sooner and improving the user experience.

In another embodiment, the framework 400 can allow for finer tuning of existing input triggers, including changing the existing triggers to provide more layer-specific data, and the addition of new triggers and policies to satisfy new scenarios. For example, a trigger can be added that will enable performance-based network switching based on aggregated performance data from the TCP/IP layers. For example, this can enable scenarios such as always using the highest speed connection available for power users that do not care about the costs of their cellular data plan.

The framework 400 includes a connection management system 420 comprising the route management engine 410, a wireless wide area network (WWAN) service 430, a wireless local area network (WLAN) service 432 and/or an Ethernet service 434.

The WWAN service 430 provides functionality to add and/or delete wireless wide area networks. In one embodiment, WWAN service 430 can use mobile telecommunication cellular network technologies to transfer data.

The WLAN service 432 provides functionality to add and/or delete wireless local area networks. In one embodiment, the WLAN service 432 can utilize a stored profile to connect to a particular Wi-Fi network when it is in range.

The Ethernet service 434 provides functionality to add and/or delete an Ethernet network.

The route management engine 410 can receive input trigger(s) from a power dependency controller (PDC) 440, a data usage subscription manager (DUSM) 442, a network location awareness/network connection status indicator (NLA/NCSI) component 444 and/or a TCP/IP component 446. Based upon the received input trigger(s), the route management engine 410 can identify a particular policy from the stored policies 450. The route management engine 410 can then apply the particular policy thus dynamically changing communication modalities based upon the received input trigger(s).

Wi-Fi to Cellular Transition

In one example, conditions which do not cause a transition by the route management engine 410 can include, for example:
1. When user doesn't allow failover to cellular when Wi-Fi is limited.
   This is per mobile operator (MO) requirement or user opt-out from the cellular user experience (UX).
2. Transition will only be done between non-domain connected non-on-demand interfaces.
   Connected on-demand interfaces should always be disabled unconstrained route/DNS look up.
3. When the interface has connected Wi-Fi with a captive portal (e.g., hijack scenario).
   In this case, the connection management system 420 can have traffic going over Wi-Fi to get stuck with captive portal until the user goes through consent/authentication in captive portal and have connectivity.
4. Cellular data usage limit has been reached.
5. The display screen is off.
6. The WWAN interface is in a Roaming state.
7. Server SKU.

In one embodiment, Wi-Fi to Cellular Transition is performed by the connection management system 420 based on these triggers:
1. Limited Wi-Fi based on NCSI/NLA 444 probing;
2. When layer 2 protocol (L2) (e.g., a data link layer for the OSI network protocol model) notifies the connection management system 420 of unacceptable connectivity quality.
3. Dead Gateway Detection notification.
4. Performance thresholds.

Cellular to Wi-Fi Transition

As a Wi-Fi connection becomes available and/or stable, the route management engine 410 can dynamically transition network traffic from cellular to Wi-Fi.

Route Management Engine

Some roles of the Route Management Engine 410 are:
1. Central place in the connection management system 420 to manage unconstrained lookup settings for interfaces.
2. Keep track of interfaces' route states.
   Route Management Engine 410 can keep track of virtual/physical interfaces and some per-interface/global states that will help the route management engine 410 to make decision whether unconstrained route lookup should be disabled on any interface. The route management engine 410 can track states that are sufficient for it to make decision on route transition.
3. Request TCP stack to tear down the connections on bad interface during transition.
4. Enforcing policy directly related to unconstrained route lookup; and/or
5. Listening to notifications that could impact route decision
   There are notifications that the route decision engine 410 can act on and make appropriate transition from Wi-Fi to cellular and back.

Notifications

In one embodiment, these are the notifications the Route Management Engine 410 can track:

1. Bad Connectivity Notification from L2 (New Notification)

When Wi-Fi connectivity is deemed unusable, WLAN service 432 passes a call back notification to the route management engine 410. The route management engine 410 can factor in the states and make the decision whether to transition from Wi-Fi to cellular or back from cellular to Wi-Fi. The route management engine 400 can already track this Wi-Fi interface when it gets this notification.

When Wi-Fi connectivity is back to usable state, WLAN service 432 will be notified through a callback that connectivity is usable

The route management engine 410 gets connected/disconnected notification to track interface connectivity. It also needs to make sure interfaces actually have IP connectivity/access to the internet by aggregating the NLA probing/connectivity.

2. Neighbor Unreachable Notification from TCP/IP 446

TCP/IP 446 will detect when a neighbor is unreachable and can notify the connection management system 420 of that case. The connection management system 420 can listen for this notification and verify when the NextHop of the one (and only) route with a NextHop IP address is flagged as Unreachable by TCP/IP 446.

### This Notification Occurs When:

1. TCP indicates to IP that a TCP connection was dropped due to dropped packets
2. IP then does an Address Resolution Protocol (ARP) to verify access to the NextHop (router)
3. If that fails, IP enters an algorithm to verify this (takes 8 seconds end-to-end to wait for a reply)
4. If that fails, IP notifies Unreachable

The connection management system 420 can take this notification into consideration when moving from WLAN to WWAN, as there is strong data that indicates that zero packets can get through WLAN.

In one example, a back-off and/or delay threshold is used to verify if this is transient or is in effect long enough to noticeably affect the use experience. In this example, repeated transitioning between WLAN and WWAN can be mitigated.

In one embodiment, the system 400 can register for notification. The system 400 can then call GetIpNetEntry2 to read the MIB_IPNET_ROW2 struct for the NextHop neighbor to see if IsUnreachable is TRUE or FALSE.

3. Dead Gateway Detection Notification from TCP Stack

The connection management system 400 can register for notifications by NotifyRouteChange2 and filter out for dead-gateway related notifications.

Dead gateway detection (DGD) can be signaled when a threshold percentage of TCP connections have failed because of retransmits. For example, the threshold percentage can be a sliding scale—with a very high percentage with a small sample size (very few connections exist—typical client usage) vs. a much lower percentage with a huge sample size (very large numbers of connections—typical enterprise server usage). As TCP connections fail, TCP will indicate this information to IP, which looks that the aggregate.

In one embodiment, Dead Gateway detection will occur only when the client is sending data—TCP only expects to receive an acknowledgement when TCP is sending data since TCP doesn't acknowledge other acknowledgements.
4. NCSI (NLA) Notifications

The connection management system 420 can rely on NLA/NCSI 444 informing the system 420 of the connectivity state of connected interfaces.
Domain interfaces will not be moved from
Transitions from Internet->Limited will trigger possible unconstrained route settings

### Internal States

The route management engine 410 can track an interface as the interface is connected and disconnected from the L2. The internal states can track interfaces that a) can be used for internet/local traffic, b) are not brought up on demand and/or c) are not tunnel interfaces. In one embodiment, the global states that are tracked are:
Connected Standby State
Feature-enabled State

Additionally, the following information can be tracked to enable the function of the route management engine 410:
Media Type
NLA State
L2 Quality State
   Assumed “good”; currently only Wi-Fi could change this setting
Dead Gateway Detection State
Neighbor Unreachable State
DPU State
   NoPlan, UnderPlan, OverPlan
Last time transitioned unconstrained-route settings
   Not calendar time, stop-watch time: can use QPF/QPC (QueryPerformanceCounter)
   0==not set

Transition logic—Handle Wi-Fi unusable, Wi-Fi limited and dead gateway detected notifications

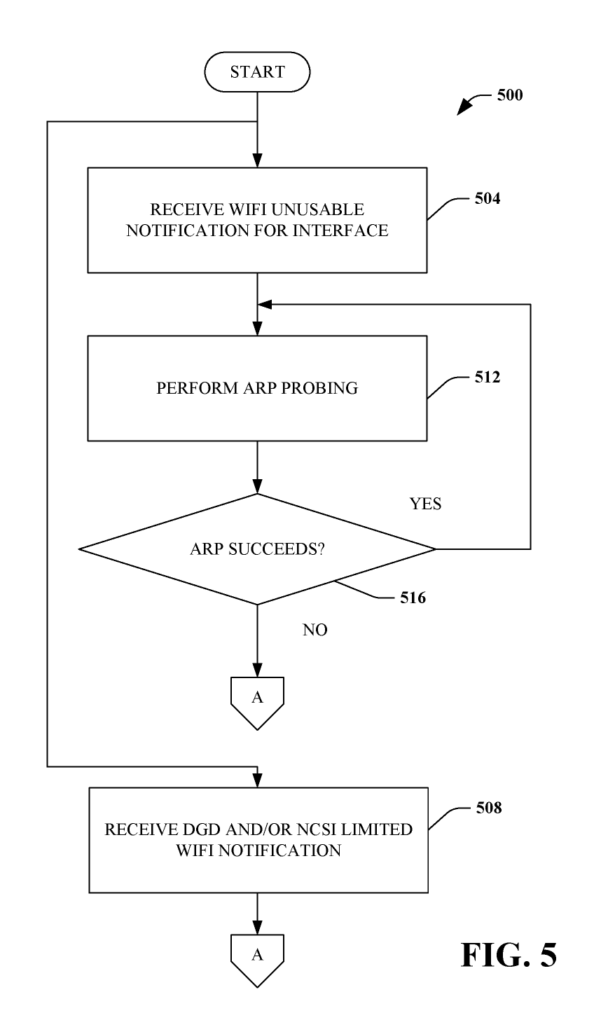

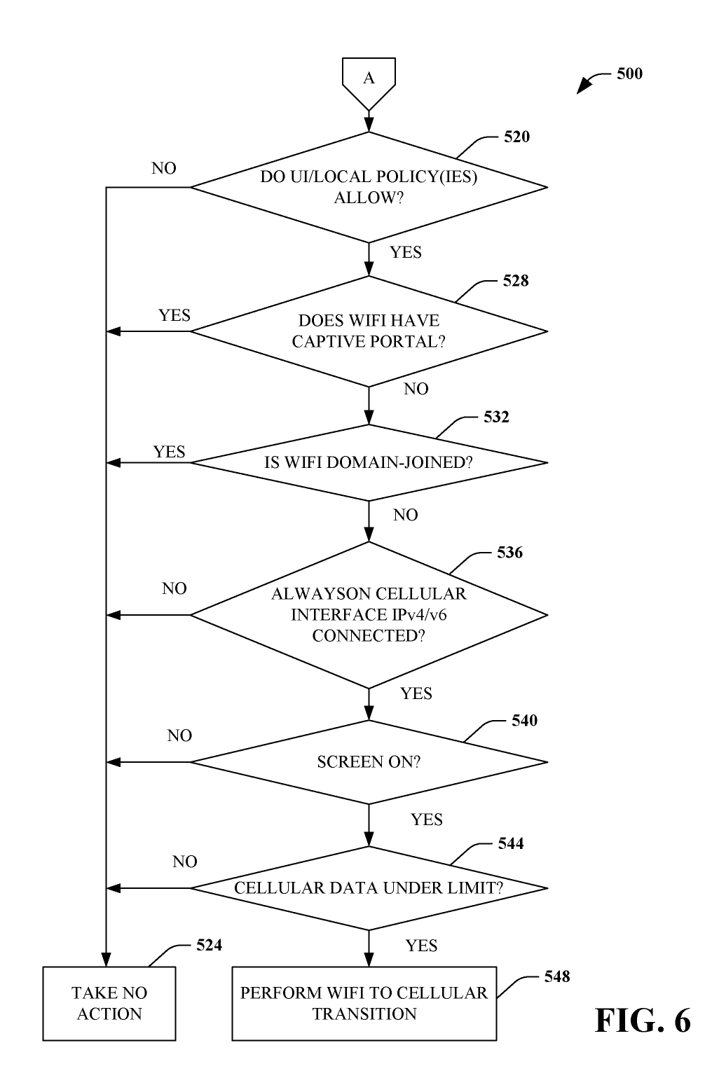

Turning to FIGS. 5 and 6, a flow diagram of a method of route management 500 is illustrated. For example, the method can be utilized by the route management engine 410 in handling “Wi-Fi unusable” notification, NCSI' s Wi-Fi Limited notification and Dead Gateway detected notification.

When Wi-Fi is connected, processing occurs at 504 and 508. At 504, a Wi-Fi unusable notification is received for an interface. At 512, ARP probing is performed. At 516, a determination is made as to whether the ARP succeeded. If the determination at 516 is YES, processing continues at 512. If the determination at 516 is NO, processing continues at 520.

At 508, a DGD and/or an NCSI limited Wi-Fi notification is received. At 520, a determination is made as to whether UI/Local policy(ies) allow for transition from Wi-Fi to cellular. If the determination at 520 is NO, processing continues at 524 where no action is taken regarding transitioning from Wi-Fi to cellular.

If the determination at 520 is YES, at 528, a determination is made as to whether the Wi-Fi has a captive portal. If the determination at 528 is YES, processing continues at 524 where no action is taken regarding transitioning from Wi-Fi to cellular.

If the determination at 528 is NO, at 532, a determination is made as to whether Wi-Fi is domain-joined. If the determination at 532 is YES, processing continues at 524 where no action is taken regarding transitioning from Wi-Fi to cellular.

If the determination at 532 is NO, at 536, a determination is made as to whether AlwaysOn Cellular interface IPv4/v6 is connected. If the determination at 536 is NO, processing continues at 524 where no action is taken regarding transitioning from Wi-Fi to cellular.

If the determination at 536 is YES, at 540, a determination is made as to whether a display screen is on. If the determination at 540 is NO, processing continues at 524 where no action is taken regarding transitioning from Wi-Fi to cellular.

If the determination at 540 is YES, at 544, a determination is made as to whether cellular data is under limit. If the determination at 544 is NO, processing continues at 524 where no action is taken regarding transitioning from Wi-Fi to cellular.

If the determination at 544 is YES, at 5248, a Wi-Fi to cellular transition is performed.

Notification Logic

Referring back to FIG. 4, in one embodiment, four sources of notifications to suggest that the WLAN interface is unusable are provided:
NCSI
WLAN service 432 Unusable notification—the WLAN service 432 can indicate when it decides that link quality is effectively unusable.
Dead Gateway Detection
   Indication from TCPIP that a high number of paths (source IP: dest

IP) have failed which terminated the TCP connection.
The heuristic on when this notification fires, based on 5 consecutive retransmits on a TCP connection, is within NL in the TCP/IP stack
The semantics of this notification is that enough paths have failed, tearing down TCP connections due to dropped data, that the route is going to fail all traffic
Neighbor Unreachable: indication from TCPIP that ARP and/or TCP packets cannot reach a neighbor
   WCM cares where the failed neighbor is NextHop for the one (and only) route off link
   The semantics of this notification is that IP cannot communicate with the router at all—not even to ARP to get its IP address (thus zero packets can go through that route)

Handle Usable Wi-Fi Notification

When the route management engine 410 receives Wi-Fi-usable notification, the route management engine 410 can check if Wi-Fi was transitioned to cellular. If Wi-Fi was transitioned to cellular, transition back to Wi-Fi.

Handle Connected and Disconnected Notification

Connected and disconnected notifications will trigger the evaluation logic to disable/enable unconstrained route and DNS lookup on interfaces. When the route management engine 410 receives one of these two notifications it will follow this process:
1. Check to make sure the interface is already tracked by the route management engine 410. If the interface is not tracked yet, add to the list of interfaces

Described herein is an extensible connection management framework, comprising a computer comprising a processor and a memory. The memory comprises a connection management system comprising a route management engine configured to select a policy from a policy store in response to a received input trigger, the route manager further configured to apply the selected policy to facilitate communication between the computer and another computer to transition from a Wi-Fi network to a cellular network, wherein the input trigger is received from a component of the computer and provides information regarding at least one of a user of the computer or a communication modality, wherein the selected policy is user-defined based on a user selection of an action to take in response to a particular input trigger.

The framework can include wherein the input trigger is received from at least one of a power dependency controller, a data usage subscription manager, a network location awareness/network connection status indicator component or a transmission connection protocol/internet protocol (TCP/IP) component. The framework can further include at least one of a wireless wide area network (WWAN) service that provides functionality to add and/or delete wireless wide area networks or wireless local area network (WLAN) service that provides functionality to add and/or delete wireless local area networks. The framework can include an Ethernet service that provides functionality to add and/or delete an Ethernet network.

The framework can include wherein the policy stores comprises a plurality of hierarchically ranked policies. The framework can further include wherein the selected policy includes context information about a user, context information about a location of the computer, context information about computer or information about a nature of the communication.

The framework can include wherein the route management engine is further configured to identify a potential problem with a particular communication modality and to proactively select another communication modality.

Described herein is a method of facilitating an extensible connection management framework, comprising: receiving an input trigger; identifying policies based upon the received input trigger; selecting a policy from the identified policies based upon a hierarchical ranking of the policies; and applying the selected policy to facilitate communication of a computing device to transition from a first communication modality to a second communication modality, wherein the selected policy is user-defined based on a user selection of an action to take in response to a particular input trigger.

The method can include wherein the input trigger is received from at least one of a power dependency controller, a data usage subscription manager, a network location awareness/network connection status indicator component or a transmission connection protocol/internet protocol (TCP/IP) component. The method can further include wherein applying the selected policy to facilitate communication comprises utilizing a wireless wide area network (WWAN) service that provides functionality to add and/or delete wireless wide area networks.

The method can include wherein applying the selected policy to facilitate communication comprises utilizing a wireless local area network (WLAN) service that provides functionality to add and/or delete wireless local area networks.

The method can include wherein applying the selected policy to facilitate communication comprises utilizing an Ethernet service that provides functionality to add and/or delete an Ethernet network. The method can further include wherein the selected policy includes context information about a user, context information about a location of the computer, context information about computer or information about a nature of the communication. The method can include wherein identifying policies further comprises identifying a potential problem with a particular communication modality and proactively selecting another communication modality.

Described herein is a computer storage media storing computer-readable instructions that when executed cause a computing device to: receive an input trigger; identify policies based upon the received input trigger; select a policy from the identified policies based upon a hierarchical ranking of the policies; and apply the selected policy to facilitate communication of a computing device to transition from a first communication modality to a second communication modality, wherein the selected policy is user-defined based on a user selection of an action to take in response to a particular input trigger.

The computer storage media can include wherein the input trigger is received from at least one of a power dependency controller, a data usage subscription manager, a network location awareness/network connection status indicator component or a transmission connection protocol/internet protocol (TCP/IP) component. The computer storage media can further include wherein apply the selected policy to facilitate communication comprises utilizing a wireless wide area network (WWAN) service that provides functionality to add and/or delete wireless wide area networks. The computer storage media can include wherein apply the selected policy to facilitate communication comprises utilizing a wireless local area network (WLAN) service that provides functionality to add and/or delete wireless local area networks.

The computer storage media can include wherein apply the selected policy to facilitate communication comprises utilizing an Ethernet service that provides functionality to add and/or delete an Ethernet network. The computer storage media can further include wherein the selected policy includes context information about a user, context information about a location of the computer, context information about computer or information about a nature of the communication

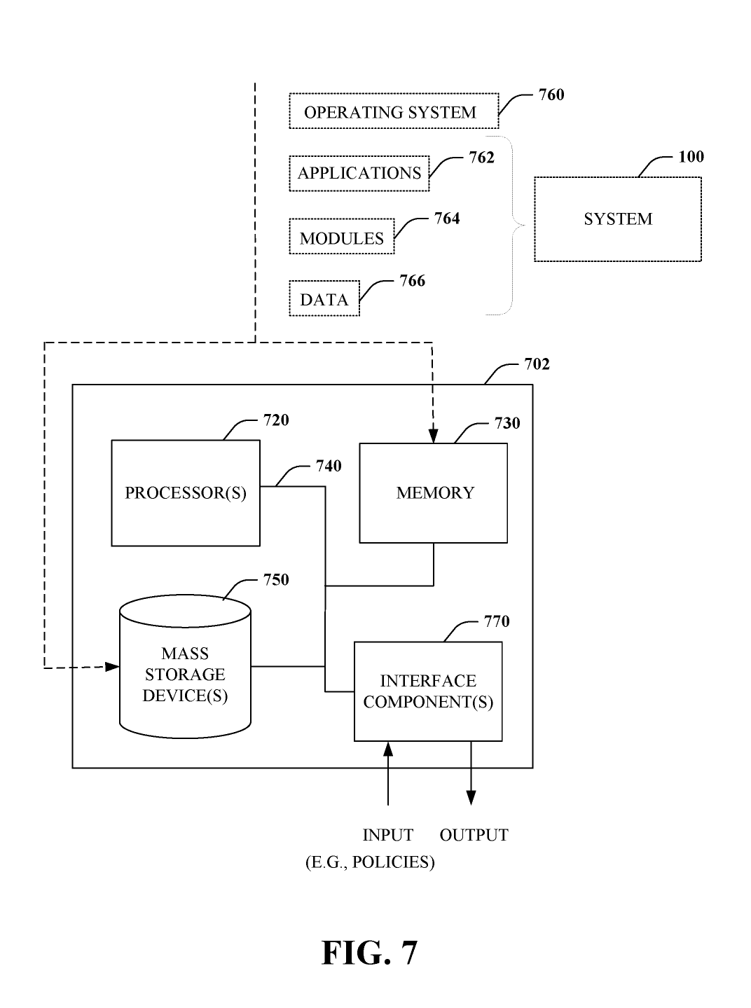

With reference to FIG. 7, illustrated is an example general-purpose computer or computing device 702 (e.g., mobile phone, desktop, laptop, tablet, watch, server, hand-held, programmable consumer or industrial electronics, set-top box, game system, compute node, etc.). For instance, the computing device 702 may be used in an extensible communication management framework 100.

The computer 702 includes one or more processor(s) 720, memory 730, system bus 740, mass storage device(s) 750, and one or more interface components 770. The system bus 740 communicatively couples at least the above system constituents. However, it is to be appreciated that in its simplest form the computer 702 can include one or more processors 720 coupled to memory 730 that execute various computer executable actions, instructions, and or components stored in memory 730. The instructions may be, for instance, instructions for implementing functionality described as being carried out by one or more components discussed above or instructions for implementing one or more of the methods described above.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 720 can be a graphics processor.

The computer 702 can include or otherwise interact with a variety of computer-readable media to facilitate control of the computer 702 to implement one or more aspects of the claimed subject matter. The computer-readable media can be any available media that can be accessed by the computer 702 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 702. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 730 and mass storage device(s) 750 are examples of computer-readable storage media. Depending on the exact configuration and type of computing device, memory 730 may be volatile (e.g., RAM), non-volatile (e.g., ROM, flash memory, etc.) or some combination of the two. By way of example, the basic input/output system (BIOS), including basic routines to transfer information between elements within the computer 702, such as during start-up, can be stored in nonvolatile memory, while volatile memory can act as external cache memory to facilitate processing by the processor(s) 720, among other things.

Mass storage device(s) 750 includes removable/non-removable, volatile/non-volatile computer storage media for storage of large amounts of data relative to the memory 730. For example, mass storage device(s) 750 includes, but is not limited to, one or more devices such as a magnetic or optical disk drive, floppy disk drive, flash memory, solid-state drive, or memory stick.

Memory 730 and mass storage device(s) 750 can include, or have stored therein, operating system 760, one or more applications 762, one or more program modules 764, and data 766. The operating system 760 acts to control and allocate resources of the computer 702. Applications 762 include one or both of system and application software and can exploit management of resources by the operating system 760 through program modules 764 and data 766 stored in memory 730 and/or mass storage device (s) 750 to perform one or more actions. Accordingly, applications 762 can turn a general-purpose computer 702 into a specialized machine in accordance with the logic provided thereby. In one example, application 762 includes key service component 160.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 762, and include one or more modules 764 and data 766 stored in memory and/or mass storage device(s) 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 702 also includes one or more interface components 770 that are communicatively coupled to the system bus 740 and facilitate interaction with the computer 702. By way of example, the interface component 770 can be a port (e.g., serial, parallel, PCMCIA, USB, FireWire, etc.) or an interface card (e.g., sound, video, etc.) or the like. In one example implementation, the interface component 770 can be embodied as a user input/output interface to enable a user to enter commands and information into the computer 702, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 770 can be embodied as an output peripheral interface to supply output to displays (e.g., LCD, LED, plasma, etc.), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An extensible connection management framework, comprising:
a computer comprising a processor and a memory, the memory comprising a connection management system comprising a route management engine configured to select a policy from a policy store in response to a received input trigger, the route manager further configured to apply the selected policy to facilitate communication between the computer and another computer to transition from a Wi-Fi network to a cellular network, wherein the input trigger is received from a component of the computer and provides information regarding at least one of a a user of the computer or a communication modality, wherein the selected policy is user-defined based on a user selection of an action to take in response to a particular input trigger.

2. The framework of claim 1, wherein the input trigger is received from at least one of a power dependency controller, a data usage subscription manager, a network location awareness/network connection status indicator component or a transmission connection protocol/internet protocol (TCP/IP) component.

3. The framework of claim 1, further comprising at least one of a wireless wide area network (WWAN) service that provides functionality to add and/or delete wireless wide area networks or a wireless local area network (WLAN) service that provides functionality to add and/or delete wireless local area networks.

4. The framework of claim 1, further comprising an Ethernet service that provides functionality to add and/or delete an Ethernet network.

5. The framework of claim 1, wherein the policy stores comprises a plurality of hierarchically ranked policies.

6. The framework of claim 1, wherein the selected policy includes context information about a user, context information about a location of the computer, context information about computer or information about a nature of the communication.

7. The framework of claim 1, wherein the route management engine is further configured to identify a potential problem with a particular communication modality and to proactively select another communication modality.

8. A method of facilitating an extensible connection management framework, comprising:
receiving an input trigger;
identifying policies based upon the received input trigger;
selecting a policy from the identified policies based upon a hierarchical ranking of the policies; and
applying the selected policy to facilitate communication of a computing device to transition from a first communication modality to a second communication modality, wherein the selected policy is user-defined based on a user selection of an action to take in response to a particular input trigger.

9. The method of claim 8, wherein the input trigger is received from at least one of a power dependency controller, a data usage subscription manager, a network location awareness/network connection status indicator component or a transmission connection protocol/internet protocol (TCP/IP) component.

10. The method of claim 8, wherein applying the selected policy to facilitate communication comprises utilizing a wireless wide area network (WWAN) service that provides functionality to add and/or delete wireless wide area networks.

11. The method of claim 8, wherein applying the selected policy to facilitate communication comprises utilizing a wireless local area network (WLAN) service that provides functionality to add and/or delete wireless local area networks.

12. The method of claim 8, wherein applying the selected policy to facilitate communication comprises utilizing an Ethernet service that provides functionality to add and/or delete an Ethernet network.

13. The method of claim 8, wherein the selected policy includes context information about a user, context information about a location of the computer, context information about computer or information about a nature of the communication.

14. The method of claim 8, wherein identifying policies further comprises identifying a potential problem with a particular communication modality and proactively selecting another communication modality.

15. A computer storage media storing computer-readable instructions that when executed cause a computing device to:
receive an input trigger;
identify policies based upon the received input trigger;
select a policy from the identified policies based upon a hierarchical ranking of the policies; and
apply the selected policy to facilitate communication of a computing device to transition from a first communication modality to a second communication modality, wherein the selected policy is user-defined based on a user selection of an action to take in response to a particular input trigger.

16. The computer storage media of claim 15, wherein the input trigger is received from at least one of a power dependency controller, a data usage subscription manager, a network location awareness/network connection status indicator component or a transmission connection protocol/internet protocol (TCP/IP) component.

17. The computer storage media of claim 15, wherein apply the selected policy to facilitate communication comprises utilizing a wireless wide area network (WWAN) service that provides functionality to add and/or delete wireless wide area networks.

18. The computer storage media of claim 15, wherein apply the selected policy to facilitate communication comprises utilizing a wireless local area network (WLAN) service that provides functionality to add and/or delete wireless local area networks.

19. The computer storage media of claim 15, wherein apply the selected policy to facilitate communication comprises utilizing an Ethernet service that provides functionality to add and/or delete an Ethernet network.

20. The computer storage media of claim 15, wherein the selected policy includes context information about a user, context information about a location of the computer, context information about computer or information about a nature of the communication.
